(19) United States
(12) Patent Application Publication
(10) Pub. No.: US 2021/0255877 A1
(43) Pub. Date: Aug. 19, 2021

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJIFILM Business Innovation Corp., Tokyo (JP)

(72) Inventor: Haruki MATSUI, Kanagawa (JP)

(73) Assignee: FUJIFILM Business Innovation Corp., Tokyo (JP)

(21) Appl. No.: 16/916,124

(22) Filed: Jun. 30, 2020

(30) Foreign Application Priority Data
Feb. 19, 2020 (JP) 2020-025890

(51) Int. Cl. G06F 9/445; H04N 1/00; G06F 8/65

(52) U.S. Cl. CPC G06F 9/44505; H04N 1/00408; G06F 8/65; H04N 1/00962; H04N 1/0048

(57) ABSTRACT

An information processing apparatus includes: a processor configured to acquire configuration information which is information on a module used in software, the software being configured with the module which realizes a predetermined function; acquire module information which is information on a module used in a device into which the software is introduced, from the device; specify the software introduced into the device, based on the configuration information and the module information; and perform control of displaying the introduced software and displaying a screen for changing a setting of the module in correspondence with the displayed software.

### CROSS-REFERENCE TO RELATED APPLICATIONS

This application is based on and claims priority under 35 USC 119 from Japanese Patent Application No. 2020-025890 filed Feb. 19, 2020.

### BACKGROUND

### (i) Technical Field

The present invention relates to an information processing apparatus, an information processing system, and a non-transitory computer readable medium storing a program.

### (ii) Related Art

Ina case where a new function is introduced into a device used by a user, the user may perform a process of adding software. At this time, the software is configured to include modules having predetermined functions, and each module is shared by a plurality of software, in some cases.

JP2011-170639A discloses an image processing apparatus. This image processing apparatus includes an input control unit which receives an input of an instruction of uninstalling a component, and an acquisition unit which acquires service subscription information and service dependence information in a case where the instruction is received. Further, a determination unit, and a notification unit which notifies a user of a determination result are provided. The determination unit checks whether or not the component related to the instruction is a component used for a service based on the service subscription information and the service dependence information. In a case where it is checked that the component is used for the service, it is determined that the uninstall is not validated, and in a case where it is checked that software is not used for the component, it is determined that the uninstall is validated.

JP2014-238886A discloses an information processing apparatus. In this information processing apparatus, via a screen in which license identification information for identifying each license of a plurality of programs can be input, a program to be installed is selected from the programs respectively corresponding to a plurality of pieces of license identification information input. In a case where dependent program on which the program selected as an installation target depends is already installed in an image forming apparatus or in the case the dependent program is selected as the installation target, it is determined whether or not to validate installation so that the program selected as the installation target can be installed, based on the selected program, the configuration information on the program already installed in the image forming apparatus, and the dependency relationship between the programs.

### SUMMARY

In a case where a user changes a setting of one piece of the software, a setting of the module is changed.

However, it is difficult for the user to grasp a relationship between the software and the module, and it is not easy to display a setting screen of the module used in the software when the user wants to change the setting of the software.

Aspects of non-limiting embodiments of the present disclosure relate to an information processing apparatus or the like capable of easily displaying a setting screen for a module constituting software in a case where a user changes a setting of the software.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to acquire configuration information which is information on a module used in software, the software being configured with the module which realizes a predetermined function; acquire module information which is information on a module used in a device into which the software is introduced, from the device; specify the software introduced into the device, based on the configuration information and the module information; and perform control of displaying the introduced software and displaying a screen for changing a setting of the module in correspondence with the displayed software.

### BRIEF DESCRIPTION OF THE DRAWINGS

Exemplary embodiment(s) of the present invention will be described in detail based on the following figures, wherein:

FIG. 1 is a diagram illustrating a configuration example of an information processing system according to the present exemplary embodiment;

FIG. 2 is a diagram illustrating a relationship between software and a module;

FIG. 3 is a diagram illustrating a hardware configuration example of an image forming apparatus;

FIG. 4 is a diagram illustrating an example of a general operation of an information processing system;

FIG. 5 is a block diagram illustrating a functional configuration example of the information processing system;

FIGS. 6A to 6D are diagrams illustrating specific examples of configuration information, product information, and module information;

FIG. 7 is a conceptual diagram illustrating a mode in which a terminal device acquires the configuration information, the product information, and the module information;

Parts (a) to (d) in FIG. 8 are diagrams illustrating a screen displayed on a display unit;

FIGS. 9A and 9B are diagrams illustrating a screen displayed when “open setting” illustrated in a part (b) in FIG. 8 is selected;

FIGS. 10A and 10B are diagrams illustrating patterns of a dialog;

FIG. 11 is a sequence diagram illustrating a case where a menu illustrated in FIG. 8 is displayed as an operation of the information processing system; and

FIG. 12 is a sequence diagram illustrating a case where a setting of a module is changed from the menu illustrated in FIG. 8 as the operation of the information processing system.

### DETAILED DESCRIPTION

Hereinafter, exemplary embodiments of the present invention will be described in detail with reference to drawings.

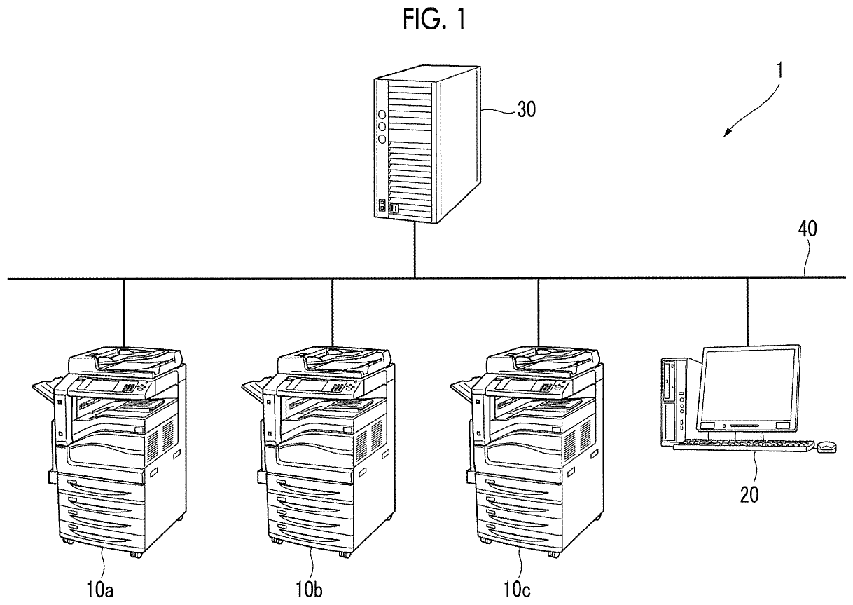

Description of Entire Information Processing System FIG. 1 is a diagram illustrating a configuration example of an information processing system 1 according to the present exemplary embodiment.

As illustrated, the information processing system 1 of the present exemplary embodiment is configured to include image forming apparatuses 10a, 10b, and 10c, a terminal device 20, and a management server 30 being connected with each other via a network 40. In a case where the image forming apparatuses 10a, 10b, and 10c are not respectively distinguished, the image forming apparatuses 10a, 10b, and 10c may be simply referred to as an image forming apparatus 10 hereinafter.

Although only three image forming apparatuses 10 and one terminal device 20 are illustrated in FIG. 1, any number may be used.

The image forming apparatus 10 is an example of a device. The image forming apparatus 10 has a printer function. That is, the image forming apparatus 10 can form an image on a recording medium such as paper and output the image as a printing medium. In addition to the printer function, the image forming apparatus 10 has other image processing functions such as a scanner function and a facsimile function. Although details will be described below, these functions are realized by being processed by software having modules which realize predetermined functions.

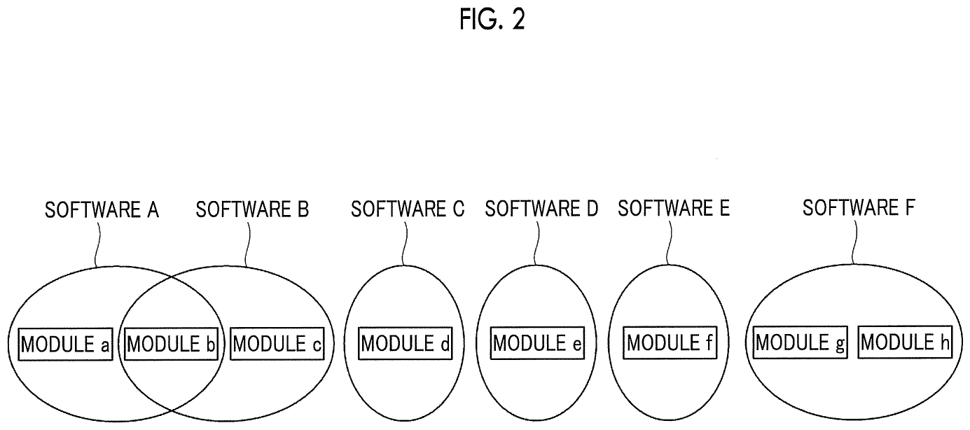

FIG. 2 is a diagram illustrating a relationship between software and modules.

FIG. 2 illustrates that software A to F is introduced into the image forming apparatus 10. The software A is configured to include two modules which are a module a and a module b. Further, software B is configured to include two modules which are the module b and a module c. In the same manner, each of software C, D, and E is configured to include one module, that is, each of a module d, a module e, and a module f. Further, software F is configured to include two modules, that is, a module g and a module h.

As illustrated, each module may be used by only one piece of software, but as the module b, one module may be commonly used by a plurality of pieces of software A and B.

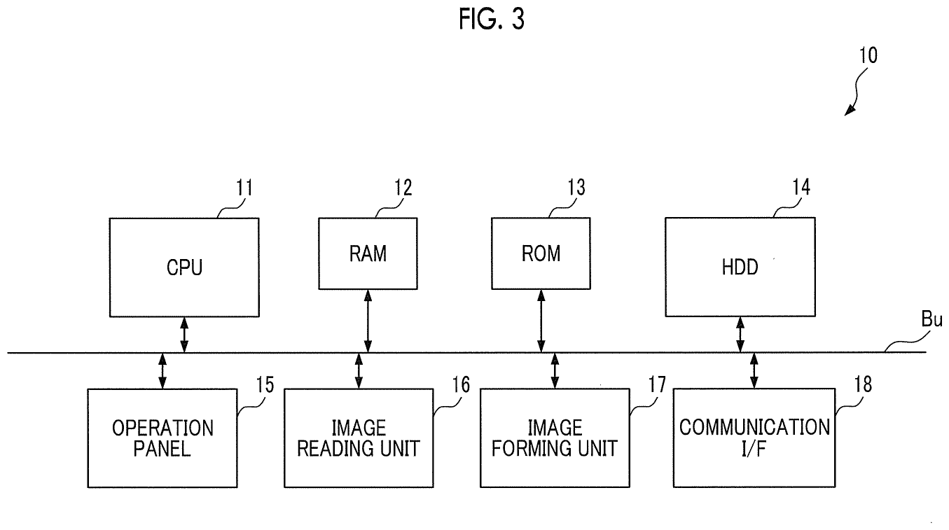

FIG. 3 is a diagram illustrating a hardware configuration example of the image forming apparatus 10.

As illustrated, the image forming apparatus 10 includes a central processing unit (CPU) 11, a random access memory (RAM) 12, a read only memory (ROM) 13, a hard disk drive (HDD) 14, and an operation panel 15, an image reading unit 16, an image forming unit 17, and a communication I/F 18. These units exchange necessary data via a bus Bu.

The RAM 12 is a memory used as a working memory of the CPU 11 and the like.

The ROM 13 is a memory which stores various programs executed by the CPU 11 and the like.

The HDD 14 is, for example, a magnetic disk device which stores image information read by the image reading unit 16, image information used for image formation by the image forming unit 17, and the like.

The operation panel 15 is, for example, a touch panel which displays various types of information or receives an operation input from a user. Therefore, a display mechanism includes a display unit such as a liquid crystal panel which displays contents (information contents) as an image in a predetermined area, and has a function of detecting a position, when a finger or a contact object typified by a stylus pen touches the liquid crystal panel, at which the contact object is in contact with the liquid crystal panel. The touch panel in the present exemplary embodiment is not particularly limited, and various methods such as a resistance film method and a capacitance method can be used.

The image reading unit 16 reads an image recorded on an original document. Here, the image reading unit 16 is, for example, a scanner, and a CCD method in which reflected light for light emitted from a light source to an original document is reduced by a lens and received by charge coupled devices (CCDs) or a CIS method in which reflected light for light emitted sequentially from a LED light source to an original document is received by a contact image sensor (CIS) may be used.

The image forming unit 17 is an example of a printing mechanism which forms an image on a recording medium. Here, the image forming unit 17 is, for example, a printer, and an electrophotographic method in which toner attached to a photoconductor is transferred to a recording medium such as paper to form an image, or an inkjet method in which an image is formed by ejecting ink onto a recording medium may be used.

The communication I/F 18 transmits and receives various types of information to and from other apparatuses via the network.

The terminal device 20 is an example of an information processing apparatus, and manages software which operates in the image forming apparatus 10. The terminal device 20 newly introduces, updates, or deletes the software as a change. These can be referred to as installing, updating, and uninstalling software, respectively.

The terminal device 20 is, for example, a general-purpose personal computer (PC). The terminal device 20 manages software of the image forming apparatus 10 by operating various application software under management of an operating system (OS).

The management server 30 stores configuration information including information indicating a module constituting the software operating in the image forming apparatus 10. That is, regarding software configured with a module which realizes a predetermined function in the image forming apparatus 10, “configuration information” is information on the module used in the software. The management server 30 transmits this configuration information to the terminal device 20 in response to an inquiry from the terminal device 20.

The management server 30 is, for example, a cloud server provided on a cloud. The management server 30 is, for example, an internal server provided on an office network.

The terminal device 20 and the management server 30 include a CPU which is a calculation section, a main memory which is a storage section, and a storage such as an HDD or a solid state drive (SSD). Here, the CPU is an example of a processor and executes various types of software such as an OS (basic software) and application software (application software). The main memory is a storage area for storing various types of software and data used for executing the software, and the storage is a storage area for storing input data to the various types of software, output data from the various types of software, and the like.

Further, the terminal device 20 and the management server 30 include a communication interface (hereinafter, referred to as “communication I/F”) for performing communication with an outside, a display mechanism consisting of a video memory, a display, or the like, and an input device such as a keyboard, a mouse, a touch panel, or a stylus pen.

The network 40 is a communication section used for information communication between the image forming apparatus 10, the terminal device 20, and the management server 30, and is, for example, a local area network (LAN) or the Internet.

Outline of Operation of Information Processing System 1

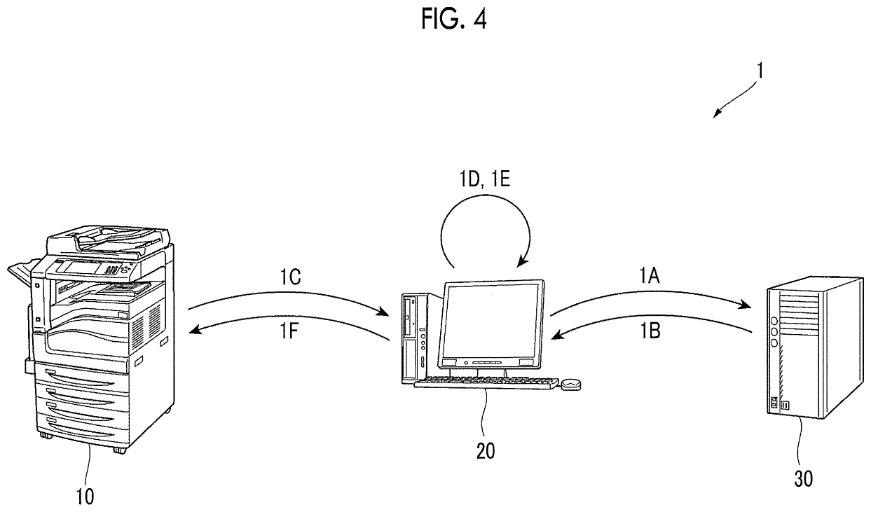

FIG. 4 is a diagram illustrating an example of a general operation of the information processing system 1.

Here, a case where a setting of software introduced into the image forming apparatus 10 is changed is considered.

At this time, the terminal device 20 inquires of the management server 30 for configuration information indicating a module used in the software in a case of changing the setting of the software (1A).

Upon receiving the inquiry, the management server 30 transmits the configuration information to the terminal device 20 (1B). The configuration information is acquired by the terminal device 20.

Next, the terminal device 20 acquires module information including information on a module used in the image forming apparatus 10 (1C). That is, the “module information” is information on the module used in the image forming apparatus 10.

In addition, the terminal device 20 compares the configuration information acquired from the management server 30 with the module information acquired from the terminal device 20, and specifies software introduced into the image forming apparatus 10 (1D).

The terminal device 20 displays a screen of changing a setting of the module in association with the software introduced into the image forming apparatus 10 (1E). This screen is displayed on the display mechanism of the terminal device 20. The terminal device 20 changes the setting of the module of the image forming apparatus 10 according to a change instruction of a user (1F).

Description of Functional Configuration of Information Processing System 1

Next, the information processing system 1 will be described in detail.

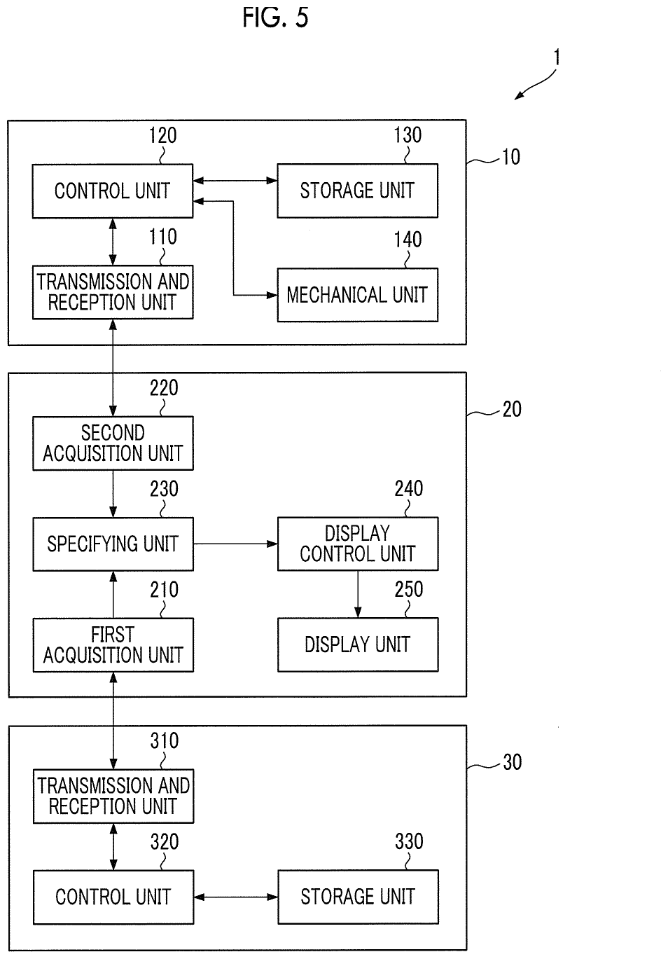

FIG. 5 is a block diagram illustrating a functional configuration example of the information processing system 1.

Here, among various functions of the information processing system 1, functions related to the present exemplary embodiment are selected and illustrated.

The image forming apparatus 10 of the information processing system 1 includes a transmission and reception unit 110 which transmits and receives information to and from an external device, a control unit 120 which controls the image forming apparatus 10, a storage unit 130 which stores modules, and a mechanical unit 140 which realizes functions of the image forming apparatus 10.

The transmission and reception unit 110 receives an instruction of changing a setting of a module, from the terminal device 20.

The transmission and reception unit 110 corresponds to, for example, the communication I/F 18 or the CPU 11.

The control unit 120 controls the entire image forming apparatus 10. Here, when the terminal device 20 gives an instruction of changing a setting of a module, the module is changed and saved in the storage unit 130. The control unit 120 corresponds to the CPU 11, the RAM 12, and the ROM 13.

The storage unit 130 saves the above-described module information in addition to modules constituting a software. The storage unit 130 corresponds to the HDD 14.

The mechanical unit 140 is, for example, the touch panel, the scanner, the printing mechanism, or the like described above. The mechanical unit 140 corresponds to the operation panel 15, the image reading unit 16, and the image forming unit 17.

The management server 30 includes a transmission and reception unit 310 which transmits and receives information to and from an external device, a control unit 320 which controls the management server 30, and a storage unit 330 which saves configuration information.

The transmission and reception unit 310 transmits the configuration information in response to an inquiry from the terminal device 20.

The control unit 320 controls the entire management server 30.

The storage unit 330 stores the configuration information described above and product information to be described below.

The terminal device 20 includes a first acquisition unit 210 which acquires configuration information, a second acquisition unit 220 which acquires module information, a specifying unit 230 which specifies software introduced into the image forming apparatus 10, and a display control unit 240 which controls a screen displayed on a display unit 250, and the display unit 250 which displays the screen for changing a setting of a module.

The first acquisition unit 210 acquires configuration information including information indicating a module constituting software which can be used by the image forming apparatus 10, from the management server 30. The first acquisition unit 210 also acquires product information from the management server 30. The product information is information necessary in a case where this software is sold as a product.

The second acquisition unit 220 acquires module information including information indicating a module actually used by the image forming apparatus 10, from the image forming apparatus 10.

The specifying unit 230 specifies software introduced into the image forming apparatus 10, from the configuration information and the module information.

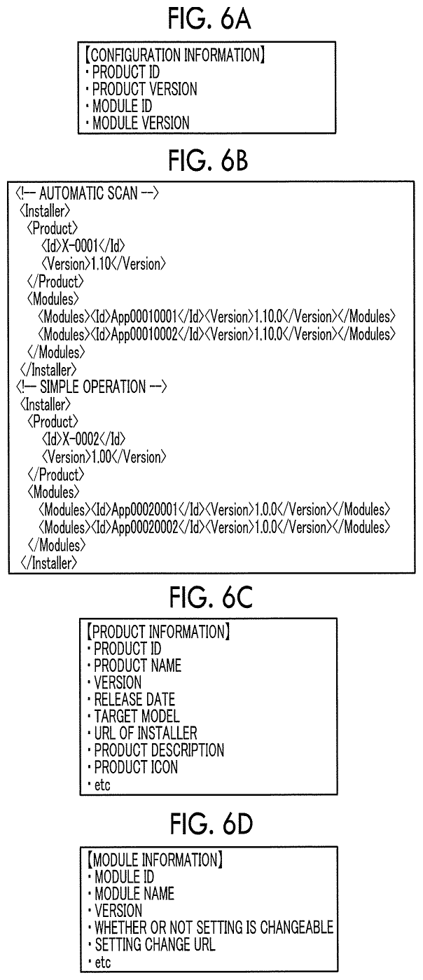

FIGS. 6A to 6D are diagrams illustrating specific examples of configuration information, product information, and module information.

Among FIGS. 6A to 6D, FIGS. 6A and 6B illustrate the configuration information.

As illustrated in FIG. 6A, the configuration information includes information on a product ID, a product version, a module ID, and a module version. FIG. 6B is a specific example of the configuration information, and the configuration information includes information on each of a product ID, a product version, a module ID, and a module version.

Further, FIG. 6C illustrates the product information.

As illustrated, the product information includes information such as a product ID, a product name, a version, a release date, a target model, an installer uniform resource locator (URL), a product description, and a product icon.

Further, FIG. 6D illustrates the module information.

As illustrated, the module information includes information such as a module ID, a module name, a version, whether or not a setting can be changed, and a URL for calling a screen for a setting change.

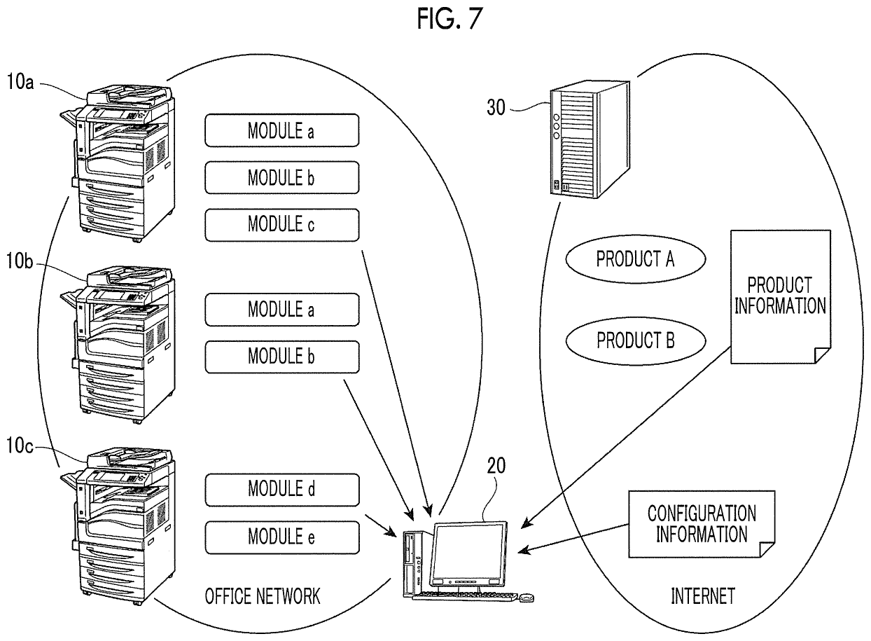

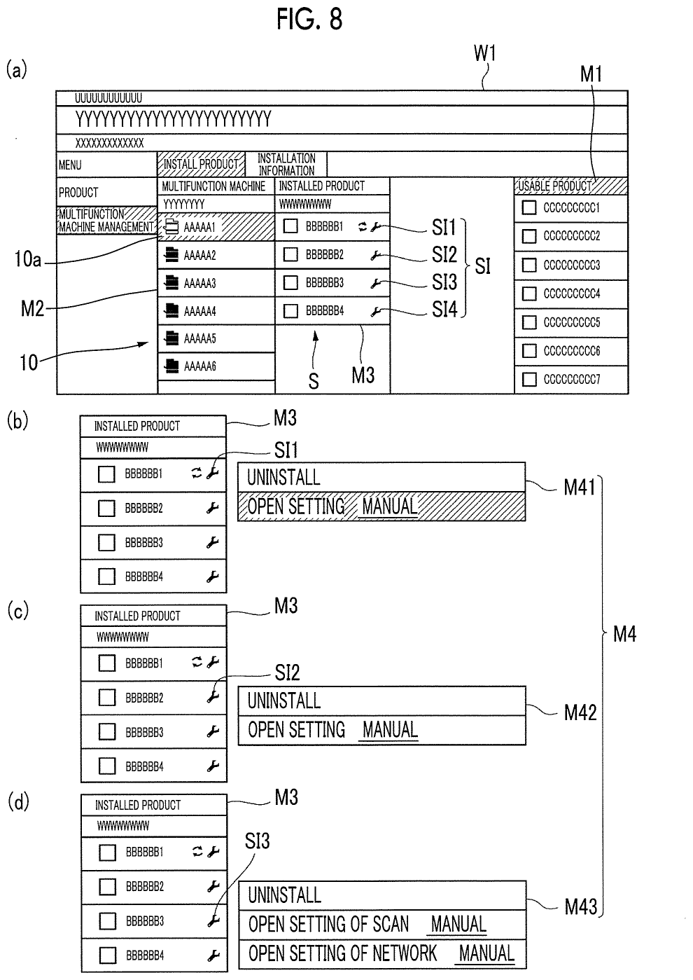

FIG. 7 is a conceptual diagram illustrating a mode in which the terminal device 20 acquires configuration information, product information, and module information.

In the illustrated example, the terminal device 20 acquires the module information from the image forming apparatuses 10a, 10b, and 10c. Here, as an example of the network 40, the office network is used to acquire the module information. A case where the terminal device 20 acquires module information on the modules a, b, and c as a module actually used by the image forming apparatus 10a is illustrated. In the same manner, the terminal device 20 acquires module information on the modules a and b as a module actually used by the image forming apparatus 10b. Further, the terminal device 20 acquires module information on the modules d and e as a module actually used by the image forming apparatus 10c.

On the other hand, the terminal device 20 acquires the configuration information and the product information from the management server 30.

Here, as an example, the configuration information and the product information regarding the software A and B are acquired.

Returning to FIG. 5, the display unit 250 displays software introduced into the image forming apparatus 10. Further, the display unit 250 displays a screen for changing a setting of a module in correspondence with the displayed software. The screen for changing the setting of the module can be called from the image forming apparatus 10. In this case, for example, the image forming apparatus 10 has a built-in Web server. The second acquisition unit 220 acquires call information which is information for calling the screen for changing the setting from the image forming apparatus 10, together with module information. This call information is, for example, a URL for calling the above-described screen for the setting change. The display control unit 240 calls and displays the screen for changing the setting, for example, with this URL.

FIG. 8 is a diagram illustrating a screen displayed on the display unit 250.

In FIG. 8, a part (a) in FIG. 8 illustrates a case where software introduced into the image forming apparatus 10 is displayed in a window W1. The illustrated window W1 displays menus M1 to M3.

Among the menus M1 to M3, the menu M1 is a list of software which can be used by the image forming apparatus 10. A user who operates the terminal device 20 can introduce new software into the image forming apparatus 10 by selecting the software from the menu M1. The selection is performed by using an input device such as a mouse or a stylus pen provided in the terminal device 20 and performing an operation such as clicking or touching on the screen.

Further, the image forming apparatus 10 of which software is managed by the terminal device 20 is displayed in the menu M2. Here, it is illustrated that the terminal device 20 manages a plurality of image forming apparatuses 10. Among the image forming apparatuses 10, one image forming apparatus 10 can be selected. The part (a) in FIG. 8 illustrates a case where the image forming apparatus 10a is selected. In this case, the menu M3 is displayed.

In the menu M3, currently introduced software S is displayed on the selected image forming apparatus 10. Here, regarding the image forming apparatus 10a, the software S specified by the specifying unit 230 is illustrated. That is, here, the selected image forming apparatus 10a and the software S introduced into the image forming apparatus 10a are displayed in association with each other. A setting icon SI for each software S is displayed in the menu M3. Here, each of setting icons SI1 to SI4 is displayed for each of four pieces of software.

Parts (b) to (d) in FIG. 8 illustrate a menu M4 displayed when the setting icon SI is selected. The parts (b) to (d) in FIG. 8 respectively illustrate menus M41 to M43 displayed when the setting icons SI1 to SI3 are selected, as the menu M4. In the menu M4, it is possible to change a setting of a module constituting each of the pieces of software S.

As illustrated in the part (b) in FIG. 8, when the setting icon SI1 is selected, each of items of “uninstall”, “open setting”, and “manual” is displayed as the menu M41, and as illustrated in the part (c) in FIG. 8, when the setting icon SI2 is selected, each of items of “uninstall”, “open setting”, and “manual” are displayed as the menu M42 in the same manner. Further, when the setting icon SI3 is selected, each of items of “uninstall”, “open setting of scan”, “manual”, “open setting of network”, and “manual” is displayed as the menu M43. In the parts (b) and (c) in FIG. 8, “open setting” of the menus M41 and M42 are displayed one by one. This means that each software is configured to include one module. On the other hand, in the part (d) in FIG. 8, two items of “open setting of scan” and “open setting of network” are displayed as “open setting” of the menu M43. This means that the software is configured to include two modules. It is possible to change a setting for each module.

In this manner, in a case where “open setting” can be selected in the menu M4, it means that the settings of these modules can be changed. On the other hand, in some cases, module does not allow the user to change a setting. In this case, “open setting” can be deactivated or hidden. That is, the display unit 250 displays a screen indicating whether or not a setting of a module can be changed depending on whether or not the setting can be changed. Information on whether or not the setting of the module can be changed can be acquired from the image forming apparatus 10 together with the module information, in the same manner as the URL for calling the setting change screen.

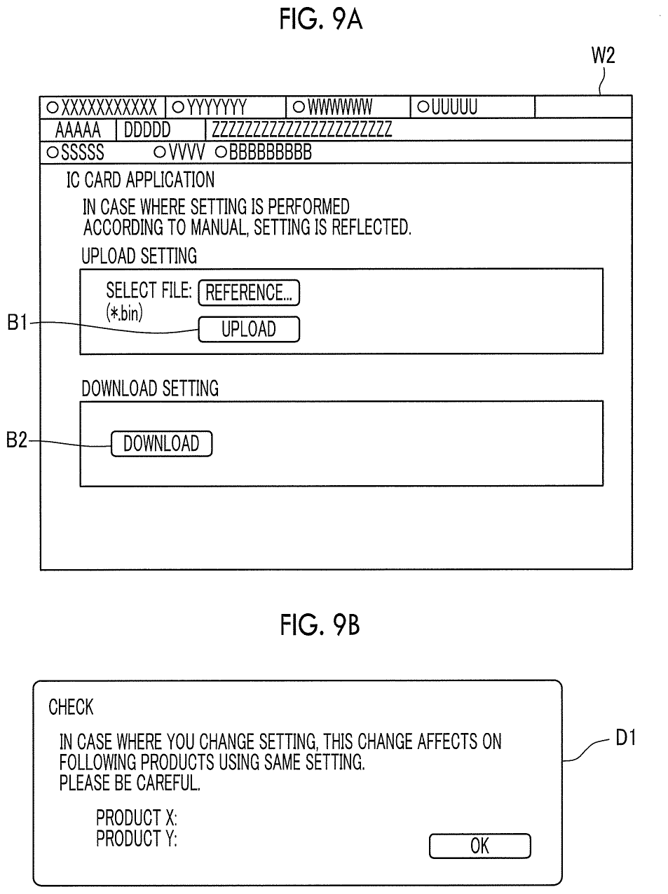

FIGS. 9A and 9B are diagrams illustrating a screen displayed when the “open setting” illustrated in the part (b) in FIG. 8 is selected.

Among FIGS. 9A and 9B, FIG. 9A is a screen for changing a setting of a module, and the screen is displayed as a window W2. Here, “upload setting” and “download setting” can be selected, and setting information can be exported in a case where a download button B2 is pressed. In addition, in a case where an upload button B1 is pressed, the setting information can be imported.

Further, FIG. 9B is a screen illustrating an influence on one piece of software in a case where the setting of the module used in another piece of software is changed, and the screen is displayed as a dialog D1. That is, as described in FIG. 2, the module may be commonly used by a plurality of pieces of software. At this time, when the setting of the commonly used module is changed, the setting change is reflected in the other piece of software which uses the module. Therefore, in a case where a setting of a module used in one piece of software is changed, an operation of another piece of software which uses this module may be affected. Therefore, in the present exemplary embodiment, the dialog D1 is displayed as a check screen for the user, as illustrated in FIG. 9B, for the user who intends to change the setting.

This dialog D1 is displayed together with the screen in FIG. 9A. When there is no influence on other pieces of software, such as in a case where a module on which a settings change is performed is used by only one piece of software and is not used by the other pieces of software, the screen in FIG. 9B is not displayed.

A plurality of patterns are prepared for the dialog D1 according to the influence on other pieces of software. The display control unit 240 selects a pattern from the plurality of patterns and displays the pattern on the display unit 250.

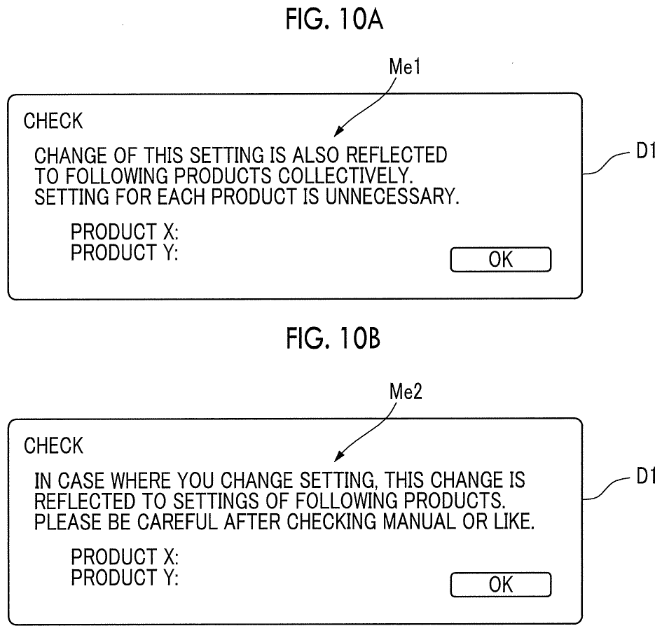

FIGS. 10A and 10B are diagrams illustrating patterns of the dialog D1.

Among FIGS. 10A and 10B, FIG. 10A illustrates the dialog D1 displayed in a case where an influence on other pieces of software is small. In this case, a message Me1 of “Change of this setting is also reflected to following products collectively. Setting for each product is unnecessary.” is displayed. Accordingly, the user is notified that settings are collectively changed as an influence on other pieces of software. An example of this case is a case where a connection setting for software to link with a cloud service is changed.

On the other hand, FIG. 10B illustrates the dialog D1 displayed in a case where the influence on other pieces of software is large. In this case, a message Me2 of “In a case where you change this setting, the change is reflected to settings of following products. Please be careful after checking manual or the like.” is displayed. Accordingly, this notifies the user that the other pieces of software may operate unexpectedly as an influence of the other pieces of software. An example of this case is a destination for scanned image information.

Further, in a case where “manual” is selected from the menu M41 to M43 illustrated in the parts (b) to (d) in FIG. 8, a screen of instructions for explaining a method of changing the setting of the module can be displayed corresponding to the displayed software. Information on the instructions is held by the management server 30, for example, and a link destination of the information is set in “manual” of the menus M41 to M43. Accordingly, the first acquisition unit 210 can acquire the information on the instructions from the management server 30 and display the information on the display unit 250.

Further, at this time, the first acquisition unit 210 can also acquire position information, which is information indicating a position of the module setting change in the instructions. Based on this position information, the display control unit 240 can display a location in the instructions in which information indicating the position of the module setting change is described. Accordingly, the user does not have to search for the corresponding location in the instructions.

The image forming apparatus 10 may have the information on the instructions. In this case, the second acquisition unit 220 acquires the information on the instructions from the image forming apparatus 10 and displays the information on the display unit 250.

Next, an operation of the information processing system 1 will be described.

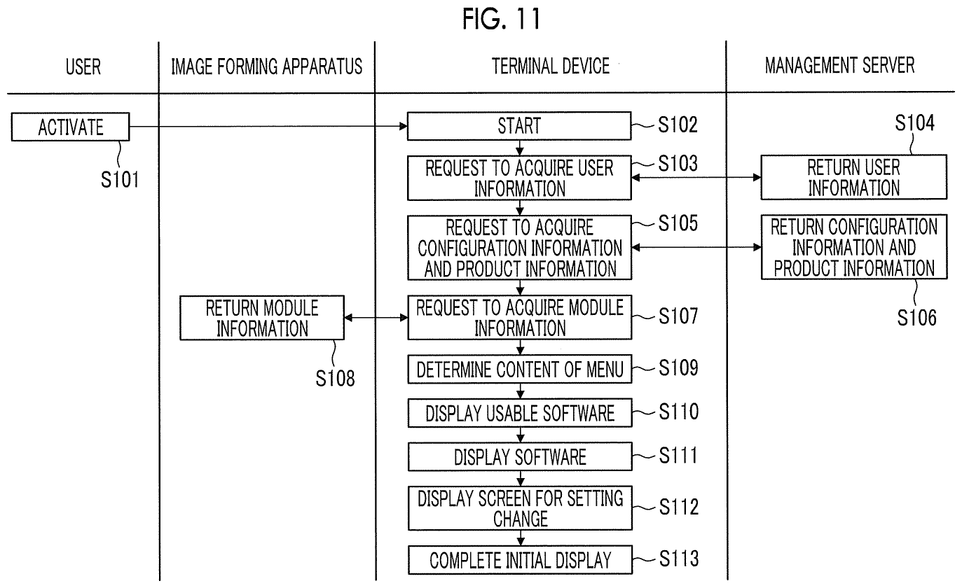

FIG. 11 is a sequence diagram illustrating a case where the menus M1 to M4 illustrated in FIG. 8 are displayed as the operation of the information processing system 1.

The illustrated sequence diagram indicates an operation of each of the user, the image forming apparatus 10, the terminal device 20, and the management server 30.

Here, first, the user activates the terminal device 20 (step S101) and starts a process in the terminal device 20 (step S102).

Next, the first acquisition unit 210 of the terminal device 20 requests the management server 30 to acquire user information (step S103), and the management server 30 returns the user information (step S104). The user information represents, for example, a user name, an acquirable product, a purchased product, and the like.

Further, the first acquisition unit 210 of the terminal device 20 requests the management server 30 to acquire configuration information and product information (step S105), and the management server 30 returns the configuration information and the product information (step S106).

Next, the second acquisition unit 220 of the terminal device 20 requests the image forming apparatus 10 to acquire module information (step S107), and the image forming apparatus 10 returns the module information (step S108). At this time, a URL for calling a screen of changing a setting or information indicating whether or not the setting of the module can be changed is also acquired.

The specifying unit 230 of the terminal device 20 determines contents of the menus M1 to M4 illustrated in FIG. 8 (step S109). Specifically, the content displayed in the menu M1 is determined from the user information. In addition, software introduced into the image forming apparatus 10 is specified from the configuration information and the module information. Further, the contents displayed in the menus M2 to M4 are determined.

The display control unit 240 of the terminal device 20 displays the menu M1 on the display unit 250. That is, the display control unit 240 displays a list of pieces of software which can be used by the image forming apparatus 10 on the display unit 250 (step S110).

Further, the display control unit 240 of the terminal device 20 displays the menus M2 to M3 on the display unit 250. That is, the display control unit 240 displays the image forming apparatus 10 of which software is managed by the terminal device 20 and the software S currently introduced into the image forming apparatus 10, on the display unit 250 (step S111).

Further, the menu M4 is displayed according to an operation of the user. That is, the display control unit 240 displays a screen for changing a setting of a module, on the display unit 250 (step S112). As described above, the operation of displaying the menus M1 to M4, which are initial displays, illustrated in FIG. 8 is completed (step S113).

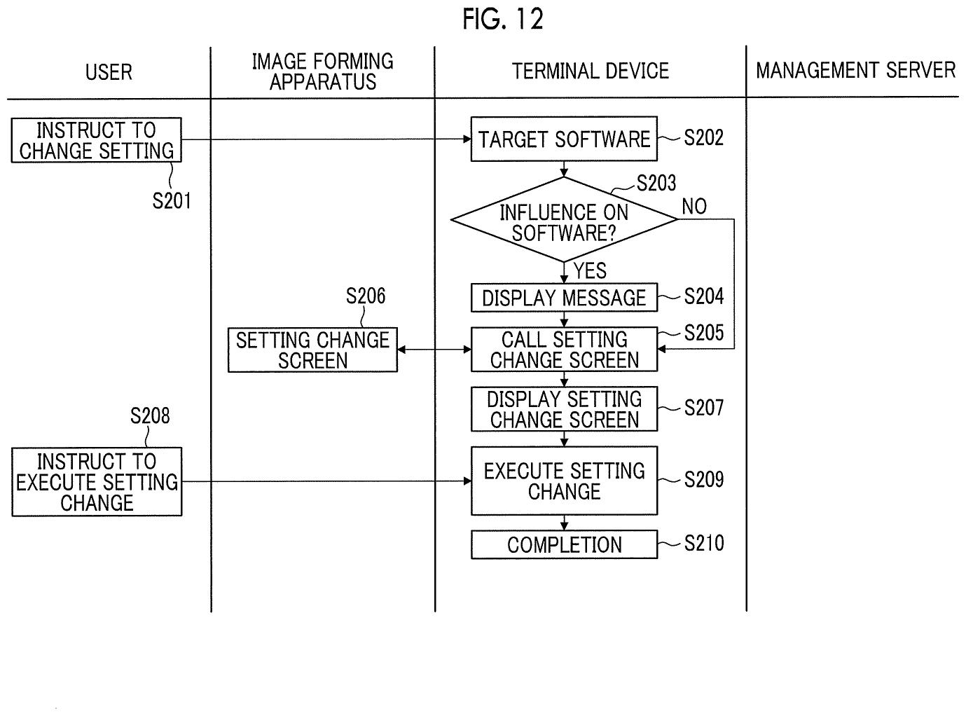

FIG. 12 is a sequence diagram illustrating a case where a setting of a module is changed, from the menu M4 illustrated in FIG. 8, as the operation of the information processing system 1.

First, the user selects “open setting” from the menu M4 and gives an instruction to change the setting (step S201).

In this case, the display control unit 240 of the terminal device 20 checks target software (step S202) and determines whether or not the setting change of the module affects other pieces of software (step S203).

As a result, in a case where there is an influence on the other pieces of software (Yes in step S203), the display control unit 240 displays a check message on the display unit 250 to the user according to the degree of influence on the other pieces of software (step S204). This is displayed, for example, as the dialog D1 illustrated in FIGS. 9B, 10A, and 10B.

On the other hand, in a case where the setting change does not affect other pieces of software (No in step S203) and after the user performs a check in step S204, the display control unit 240 calls the screen for changing the setting of the module from the image forming apparatus 10 (step S205), and the image forming apparatus 10 returns the screen for setting change (step S206) and the screen is displayed on the terminal device 20 (step S207). The screen is displayed as, for example, the window W2 illustrated in FIG. 9A.

In a case where the user gives an execution instruction to change the setting of the module (step S208), the setting of the module of the software introduced into the image forming apparatus 10 is changed (step S209). As described above, the setting change of the module is completed (step S210).

According to the terminal device 20 described above, in a case where the user changes the setting of the software, it is possible to easily display the setting screen for the module constituting the software.

Further, the terminal device 20 can grasp the relationship between the software and the module more accurately, and can directly display the setting screen of the module in association with the software. The user does not necessarily have to be aware of the module in a case of changing the setting of the software. Further, by the check screens illustrated in FIGS. 9B, 10A, and 10B, the user can grasp the influence on other pieces of software in a case where changing the setting of the software.

In the example described above, the terminal device 20 manages the software of the image forming apparatus 10, but the example is not limited thereto. For example, the management server 30 may perform the process of the terminal device 20. In addition, the management server 30 has the configuration information and the terminal device 20 acquires the configuration information, but the acquisition destination of the configuration information is not particularly limited. For example, based on information published on the Internet, the configuration information may be collected, or may be acquired from another terminal device.

Further, in the above-described example, the device is the image forming apparatus 10, but the device is not limited to this. That is, any device may be used as long as the software configured with the module is changed by an operation of another device. Examples of the device include ordinary PCs, mobile phones, smartphones, tablets, and network devices such as wireless LAN routers.

Description of Program

Here, the process performed by the terminal device 20 of the present exemplary embodiment described above is prepared, for example, as a program such as application software. The process is realized by cooperation of application software and hardware resources.

Therefore, the program which executes the process performed by the terminal device 20 according to the present exemplary embodiment can also be regarded as a program causing a computer to realize: a first acquisition function of acquiring configuration information which is information on a module used in software, the software being configured with the module which realizes a predetermined function; a second acquisition function of acquiring module information which is information on a module used in a device into which the software is introduced, from the device; a specifying function of specifying the software introduced into the device, based on the configuration information and the module information; and a display control function of performing control of displaying the introduced software and displaying a screen for changing a setting of the module in correspondence with the displayed software.

A program for realizing the present exemplary embodiment can be provided by a communication section as well as provided by being stored in a recording medium such as a CD-ROM or the like.

Although the present exemplary embodiments are described above, a technical scope of the exemplary embodiments of the present invention is not limited to the scope described in the exemplary embodiments described above. Various modifications or improvements are added to the exemplary embodiments described above within the technical scope of the exemplary embodiments of the present invention, and are apparent from a scope of the description of the claims.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to
acquire configuration information which is information on a module used in software, the software being configured with the module which realizes a predetermined function;
acquire module information which is information on a module used in a device into which the software is introduced, from the device;
specify the software introduced into the device, based on the configuration information and the module information; and
perform control of displaying the introduced software and displaying a screen for changing a setting of the module in correspondence with the displayed software.

2. The information processing apparatus according to claim 1,
wherein the processor is configured to further acquire call information, which is information for calling the screen for changing the setting, from the device, and call and display the screen for changing the setting based on the call information.

3. The information processing apparatus according to claim 1,
wherein the processor is configure to display a screen indicating whether or not the setting of the module is changeable.

4. The information processing apparatus according to claim 1,
wherein the processor is configured to, in a case where the setting of the module used in one piece of software is changed, further display a screen indicating an influence on other pieces of software.

5. The information processing apparatus according to claim 4,
wherein the processor is configured to prepare a plurality of patterns regarding the influence on the other pieces of software, select a pattern from the plurality of patterns, and display the pattern.

6. The information processing apparatus according to claim 1,
wherein the processor is configured to further display a screen of instructions describing a method of changing the setting of the module in correspondence with the displayed software.

7. The information processing apparatus according to claim 6,
wherein the processor is configured to acquire position information, which is information indicating a position of a setting change of the module in the instructions, and display a location at which the information indicating the position of the setting change of the module is described in the instructions.

8. An information processing system including a device that executes processing by software configured with a module which realizes a predetermined function, and an information processing apparatus that manages the software, the information processing apparatus comprising:
a processor configured to
acquire configuration information which is information on a module used in software, the software being configured with the module which realizes a predetermined function;
acquire module information which is information on a module used in a device into which the software is introduced, from the device;
specify the software introduced into the device, based on the configuration information and the module information; and
perform control of displaying the introduced software and displaying a screen for changing a setting of the module in correspondence with the displayed software.

9. A non-transitory computer readable medium storing a program causing a computer to realize:
a first acquisition function of acquiring configuration information which is information on a module used in software, the software being configured with the module which realizes a predetermined function;
a second acquisition function of acquiring module information which is information on a module used in a device into which the software is introduced, from the device;
a specifying function of specifying the software introduced into the device, based on the configuration information and the module information; and
a display control function of performing control of displaying the introduced software and displaying a screen for changing a setting of the module in correspondence with the displayed software.
